(19) United States
(12) Patent Application Publication
(10) Pub. No.: US 2015/0330261 A1
(43) Pub. Date: Nov. 19, 2015

(54) Waste Heat Recovery Systems Having Magnetic Liquid Seals

(71) Applicant: Timothy Held, Akron, OH (US)

(72) Inventor: Timothy Held, Akron, OH (US)

(73) Assignee: Echogen Power Systems, L.L.C., Akron, OH (US)

(21) Appl. No.: 14/707,041

(22) Filed: May 8, 2015

Related U.S. Application Data
(60) Provisional application No. 61/993,530, filed on May 15, 2014.

(51) Int. Cl. F01K 23/02; F02G 5/02

(52) U.S. Cl. CPC F01K 23/02; F02G 5/02

(57) ABSTRACT

A system including a seal cartridge is provided. The seal cartridge includes a housing defining a passageway that receives a driveshaft. A dry gas seal is circumferentially disposed about the passageway within the housing at a first axial location along the housing. A magnetic liquid seal is circumferentially disposed about the passageway within the housing at a second axial location along the housing. A fluid leakage cavity is formed between the dry gas seal at the first axial location and the magnetic liquid seal at the second axial location. An extraction port is disposed in the housing and enables recovery of a leaked fluid from the fluid leakage cavity.

### CROSS-REFERENCE TO RELATED APPLICATIONS

This application claims the benefit of U.S. Prov. Appl. No. 61/993,530, entitled “Waste Heat Recovery Systems Having Magnetic Liquid Seals” filed May 15, 2014. This application is incorporated herein by reference in its entirety to the extent consistent with the present application.

### BACKGROUND

Waste heat is often created as a byproduct of industrial processes where flowing streams of high-temperature liquids, gases, or fluids must be exhausted into the environment or removed in some way in an effort to maintain the operating temperatures of the industrial process equipment. Some industrial processes utilize heat exchanger devices to capture and recycle waste heat back into the process via other process streams. However, the capturing and recycling of waste heat is generally infeasible by industrial processes that utilize high temperatures or have insufficient mass flow or other unfavorable conditions.

Waste heat can be converted into useful energy by a variety of turbine generator or heat engine systems that employ thermodynamic methods, such as Rankine cycles. Rankine cycles and similar thermodynamic methods are typically steam-based processes that recover and utilize waste heat to generate steam for driving a turbine, turbo, or other expander connected to an electric generator or pump. An organic Rankine cycle utilizes a lower boiling-point working fluid, instead of water, during a traditional Rankine cycle. Exemplary lower boiling-point working fluids include hydrocarbons, such as light hydrocarbons (e.g., propane or butane) and halogenated hydrocarbon, such as hydrochlorofluorocarbons (HCFCs) or hydrofluorocarbons (HFCs) (e.g., R245fa). More recently, in view of issues such as thermal instability, toxicity, flammability, and production cost of the lower boiling-point working fluids, some thermodynamic cycles have been modified to circulate non-hydrocarbon working fluids, such as ammonia.

In a closed loop thermodynamic cycle, working fluid may be lost to the surrounding environment through leak paths, thus creating a reduced flow of working fluid through the working fluid circuit. Accordingly, the working fluid may need to be replenished from an external source to maintain the volume of working fluid substantially constant in the working fluid circuit during operation. While it may be possible to provide working fluid from the external source in some applications, the need to replenish the working fluid in this manner may result in reduced cycle efficiency and increased operational costs. Further, in certain applications, such as shipboard or offshore applications, resupply of the working fluid may be difficult. Further, in certain applications, where operation in confined spaces is necessary, or the working fluid has some degree of toxicity, complete elimination of fugitive emissions of the fluid is desired. Therefore, there is a need for systems and methods for generating electrical energy in which the leakage of working fluid from the closed loop thermodynamic cycle is reduced or eliminated.

### SUMMARY

In one embodiment, a heat engine system includes a working fluid circuit having a high pressure side and a low pressure side and being capable of flowing a working fluid therethrough. At least a portion of the working fluid includes supercritical carbon dioxide. The heat engine system also includes a turbopump coupled to the working fluid circuit. The turbopump includes a pump portion, a drive turbine coupled to the pump portion, fluidly coupled to and disposed between the high pressure side and the low pressure side, and adapted to convert a pressure drop in the working fluid to mechanical energy. A driveshaft is coupled to the drive turbine and the pump portion and adapted to drive the pump portion with the mechanical energy to enable the pump portion to circulate the working fluid through the working fluid circuit. The driveshaft is at least partially contained within a housing. A dry gas seal is circumferentially disposed about the driveshaft between the driveshaft and the housing at a first axial location along the driveshaft. A magnetic liquid seal is circumferentially disposed about the driveshaft between the driveshaft and the housing at a second axial location along the driveshaft. A fluid leakage cavity is formed between the dry gas seal at the first axial location and the magnetic liquid seal at the second axial location. An extraction port is disposed in the housing and adapted to enable recovery of a leaked fluid from the fluid leakage cavity.

In another embodiment, a heat engine system includes a working fluid circuit having a high pressure side and a low pressure side and being adapted to flow a working fluid therethrough. At least a portion of the working fluid circuit contains the working fluid in a supercritical state. A turbopump is fluidly coupled to the working fluid circuit between the low pressure side and the high pressure side and adapted to circulate the working fluid within the working fluid circuit. A magnetic liquid seal is disposed in the turbopump and includes a ferrofluid and a magnet adapted to maintain the ferrofluid in a ring shape to seal a fluid leakage cavity of the turbopump from a lube oil system of the turbopump.

In another embodiment, a heat engine system includes a working fluid circuit having a high pressure side and a low pressure side and being adapted to flow a working fluid therethrough. The working fluid is in a supercritical state in at least a portion of working fluid circuit. A turbopump is coupled to the working fluid circuit and includes a pump portion and a drive turbine coupled to the pump portion via a driveshaft. The driveshaft is at least partially contained within a housing. A dry gas seal is circumferentially disposed about the driveshaft between the driveshaft and the housing at a first axial location along the driveshaft. A magnetic liquid seal is circumferentially disposed about the driveshaft between the driveshaft and the housing at a second axial location along the driveshaft. A fluid leakage cavity is formed between the dry gas seal at the first axial location and the magnetic liquid seal at the second axial location. A cooling system is fluidly coupled to the working fluid circuit and the magnetic liquid seal and adapted to transfer the working fluid from the working fluid circuit to the magnetic liquid seal to cool the magnetic liquid seal.

In another embodiment, a heat engine system includes a working fluid circuit having a high pressure side and a low pressure side and being capable of flowing a working fluid therethrough. At least a portion of the working fluid includes supercritical carbon dioxide. A heat exchanger is fluidly coupled to and in thermal communication with the working fluid in the high pressure side of the working fluid circuit. The heat exchanger transfers thermal energy from a heat source stream to the working fluid in the high pressure side. A power turbine is fluidly coupled to and disposed between the high pressure side and the low pressure side of the working fluid circuit and converts a pressure drop in the working fluid to mechanical energy. A driveshaft is coupled to the power turbine and drives a device with the mechanical energy. The driveshaft is at least partially contained within a housing. A dry gas seal is circumferentially disposed about the driveshaft between the driveshaft and the housing at a first axial location along the driveshaft. A magnetic liquid seal is circumferentially disposed about the driveshaft between the driveshaft and the housing at a second axial location along the driveshaft. A fluid leakage cavity is formed between the dry gas seal at the first axial location and the magnetic liquid seal at the second axial location. An extraction port is disposed in the housing and enables recovery of a leaked fluid from the fluid leakage cavity.

In another embodiment, a system includes a seal cartridge. The seal cartridge includes a housing defining a passageway that receives a driveshaft. A dry gas seal is circumferentially disposed about the passageway within the housing at a first axial location along the housing. A magnetic liquid seal is circumferentially disposed about the passageway within the housing at a second axial location along the housing. A fluid leakage cavity is formed between the dry gas seal at the first axial location and the magnetic liquid seal at the second axial location. An extraction port is disposed in the housing and enables recovery of a leaked fluid from the fluid leakage cavity.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a schematic of a heat engine system, according to one or more embodiments disclosed herein.

FIG. 2 illustrates a cross sectional view of a turbopump, according to one or more embodiments disclosed herein.

FIG. 3 illustrates a cross sectional view of a seal cartridge of a turbopump, according to one or more embodiments disclosed herein.

FIG. 4 is a schematic illustrating components of a magnetic fluid seal and a cooling system for cooling such components, according to one or more embodiments disclosed herein.

FIG. 5 is a flow chart illustrating a method for recovering fluid leakage in a turbopump, according to one or more embodiments disclosed herein.

### DETAILED DESCRIPTION

As described in more detail below, presently disclosed embodiments are directed to systems and methods for efficiently transforming thermal energy of a heat stream (e.g., a waste heat stream) into valuable electrical energy. The provided embodiments enable the reduction or prevention of leakage of a working fluid from a working fluid circuit during operation of the thermodynamic cycle. For example, in some embodiments, a heat engine system is configured to maintain the working fluid (e.g., sc-CO₂) within the low pressure side of a working fluid circuit in a liquid-type state, such as a supercritical state, during some or all of the operational period of the working fluid circuit, and leakage of the working fluid from one or more rotating shaft seals in a turbopump circulating the working fluid is reduced or prevented. In one embodiment, residual leakage from a dry gas seal may be captured in a fluid leakage cavity and isolated from a lube oil system by employing a magnetic liquid seal that separates the fluid leakage cavity from the lube oil system. The residual leakage results in fluid leakage that may be removed from the fluid leakage cavity and provided to a leak recapture compressor that compresses the leaked fluid before the leaked fluid is recycled back into the working fluid circuit. In this way, in some embodiments, the residual leakage from the dry gas seal may be recovered and utilized, thus reducing inefficiencies in the thermodynamic cycle and the need for the working fluid to be replenished from an external source. These and other features of presently disclosed embodiments are discussed in more detail below.

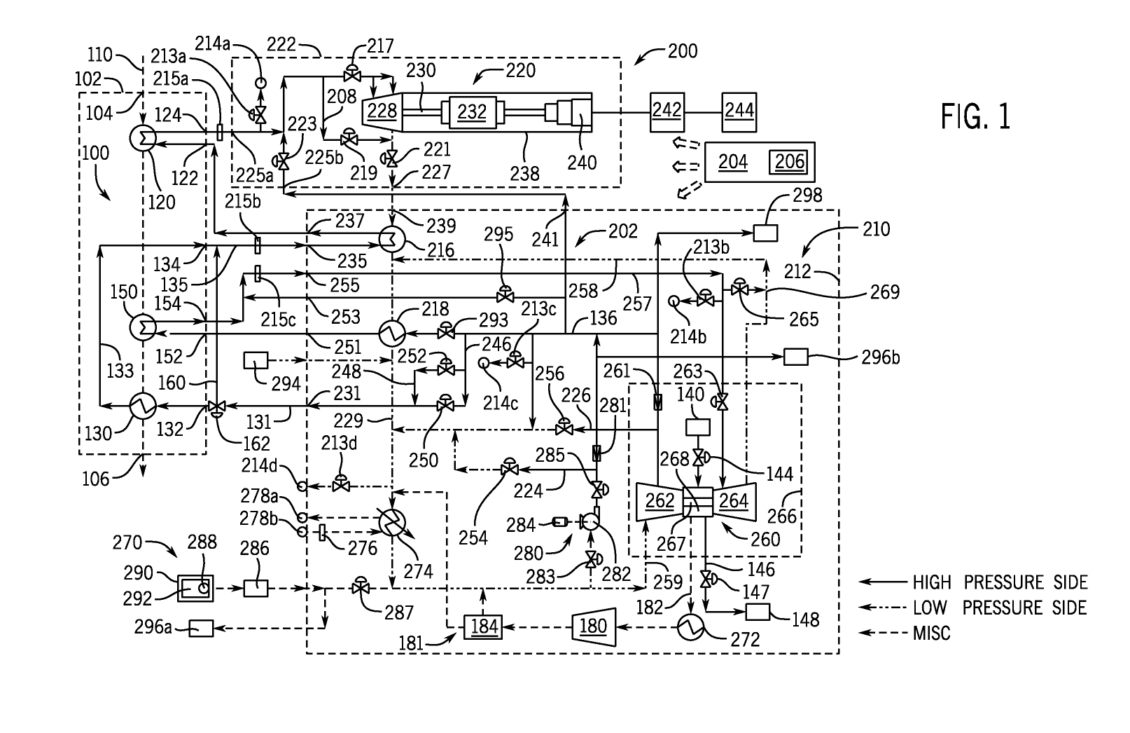

Turning now to the drawings, FIG. 1 illustrates an embodiment of a heat engine system 200, which may also be referred to as a thermal engine system, an electrical generation system, a waste heat or other heat recovery system, and/or a thermal to electrical energy system, as described in one or more embodiments below. The heat engine system 200 is generally configured to encompass one or more elements of a Rankine cycle, a derivative of a Rankine cycle, or another thermodynamic cycle for generating electrical energy from a wide range of thermal sources. The heat engine system 200 includes a waste heat system 100 and a power generation system 220 coupled to and in thermal communication with each other via a working fluid circuit 202 disposed within a process system 210. During operation, a working fluid, such as supercritical carbon dioxide (sc-CO₂), is circulated through the working fluid circuit 202, and heat is transferred to the working fluid from a heat source stream 110 flowing through the waste heat system 100. Once heated, the working fluid is circulated through a power turbine 228 within the power generation system 220 where the thermal energy contained in the heated working fluid is converted to mechanical energy. In this way, the process system 210, the waste heat system 100, and the power generation system 220 cooperate to convert the thermal energy in the heat source stream 110 into mechanical energy, which may be further converted into electrical energy if desired, depending on implementation-specific considerations.

More specifically, in the embodiment of FIG. 1, the waste heat system 100 contains three heat exchangers (i.e., the heat exchangers 120, 130, and 150) fluidly coupled to a high pressure side of the working fluid circuit 202 and in thermal communication with the heat source stream 110. Such thermal communication provides the transfer of thermal energy from the heat source stream 110 to the working fluid flowing throughout the working fluid circuit 202. In one or more embodiments disclosed herein, two, three, or more heat exchangers may be fluidly coupled to and in thermal communication with the working fluid circuit 202, such as a primary heat exchanger, a secondary heat exchanger, a tertiary heat exchanger, respectively the heat exchangers 120, 150, and 130. For example, the heat exchanger 120 may be the primary heat exchanger fluidly coupled to the working fluid circuit 202 upstream of an inlet of the power turbine 228, the heat exchanger 150 may be the secondary heat exchanger fluidly coupled to the working fluid circuit 202 upstream of an inlet of the drive turbine 264 of the turbine pump 260, and the heat exchanger 130 may be the tertiary heat exchanger fluidly coupled to the working fluid circuit 202 upstream of an inlet of the heat exchanger 120. However, it should be noted that in other embodiments, any desired number of heat exchangers, not limited to three, may be provided in the waste heat system 100.

Further, the waste heat system 100 also contains an inlet 104 for receiving the heat source stream 110 and an outlet 106 for passing the heat source stream 110 out of the waste heat system 100. The heat source stream 110 flows through and from the inlet 104, through the heat exchanger 120, through one or more additional heat exchangers, if fluidly coupled to the heat source stream 110, and to and through the outlet 106. In some examples, the heat source stream 110 flows through and from the inlet 104, through the heat exchangers 120, 150, and 130, respectively, and to and through the outlet 106. The heat source stream 110 may be routed to flow through the heat exchangers 120, 130, 150, and/or additional heat exchangers in other desired orders.

In some embodiments described herein, the waste heat system 100 is disposed on or in a waste heat skid 102 fluidly coupled to the working fluid circuit 202, as well as other portions, sub-systems, or devices of the heat engine system 200. The waste heat skid 102 may be fluidly coupled to a source of an exhaust for the heat source stream 110, a main process skid 212, a power generation skid 222, and/or other portions, sub-systems, or devices of the heat engine system 200.

In one or more configurations, the waste heat system 100 disposed on or in the waste heat skid 102 generally contains inlets 122, 132, and 152 and outlets 124, 134, and 154 fluidly coupled to and in thermal communication with the working fluid within the working fluid circuit 202. The inlet 122 is disposed upstream of the heat exchanger 120, and the outlet 124 is disposed downstream from the heat exchanger 120. The working fluid circuit 202 is configured to flow the working fluid from the inlet 122, through the heat exchanger 120, and to the outlet 124 while transferring thermal energy from the heat source stream 110 to the working fluid by the heat exchanger 120. The inlet 152 is disposed upstream of the heat exchanger 150, and the outlet 154 is disposed downstream from the heat exchanger 150. The working fluid circuit 202 is configured to flow the working fluid from the inlet 152, through the heat exchanger 150, and to the outlet 154 while transferring thermal energy from the heat source stream 110 to the working fluid by the heat exchanger 150. The inlet 132 is disposed upstream of the heat exchanger 130, and the outlet 134 is disposed downstream from the heat exchanger 130. The working fluid circuit 202 is configured to flow the working fluid from the inlet 132, through the heat exchanger 130, and to the outlet 134 while transferring thermal energy from the heat source stream 110 to the working fluid by the heat exchanger 130.

The heat source stream 110 that flows through the waste heat system 100 may be a waste heat stream such as, but not limited to, a gas turbine exhaust stream, an industrial process exhaust stream, or any other combustion product exhaust stream, such as a furnace or boiler exhaust stream. The heat source stream 110 may be at a temperature within a range from about 100° C. to about 1,000° C., or greater than 1,000° C., and in some examples, within a range from about 200° C. to about 800° C., more narrowly within a range from about 300° C. to about 600° C. The heat source stream 110 may contain air, carbon dioxide, carbon monoxide, water or steam, nitrogen, oxygen, argon, derivatives thereof, or mixtures thereof. In some embodiments, the heat source stream 110 may derive thermal energy from other sources of thermal energy, such as solar, geothermal, or nuclear sources.

Turning now to the power generation system 220, the illustrated embodiment includes the power turbine 228 disposed between a high pressure side and a low pressure side of the working fluid circuit 202. The power turbine 228 is configured to convert thermal energy to mechanical energy by a pressure drop in the working fluid flowing between the high and the low pressure sides of the working fluid circuit 202. A power generator 240 is coupled to the power turbine 228 and configured to convert the mechanical energy into electrical energy. In certain embodiments, a power outlet 242 may be electrically coupled to the power generator 240 and configured to transfer the electrical energy from the power generator 240 to an electrical grid 244. The illustrated power generation system 220 also contains a driveshaft 230 and a gearbox 232 coupled between the power turbine 228 and the power generator 240.

In one or more configurations, the power generation system 220 is disposed on or in the power generation skid 222 that contains inlets 225a, 225b and an outlet 227 fluidly coupled to and in thermal communication with the working fluid within the working fluid circuit 202. The inlets 225a, 225b are upstream of the power turbine 228 within the high pressure side of the working fluid circuit 202 and are configured to receive the heated and high pressure working fluid. In some examples, the inlet 225a may be fluidly coupled to the outlet 124 of the waste heat system 100 and configured to receive the working fluid flowing from the heat exchanger 120. Further, the inlet 225b may be fluidly coupled to the outlet 241 of the process system 210 and configured to receive the working fluid flowing from the turbopump 260 and/or the start pump 280. The outlet 227 is disposed downstream from the power turbine 228 within the low pressure side of the working fluid circuit 202 and is configured to provide the low pressure working fluid. In some examples, the outlet 227 may be fluidly coupled to the inlet 239 of the process system 210 and configured to flow the working fluid to the recuperator 216.

A filter 215a may be disposed along and in fluid communication with the fluid line at a point downstream from the heat exchanger 120 and upstream of the power turbine 228. In some examples, the filter 215a is fluidly coupled to the working fluid circuit 202 between the outlet 124 of the waste heat system 100 and the inlet 225a of the process system 210.

Again, the portion of the working fluid circuit 202 within the power generation system 220 is fed the working fluid by the inlets 225a and 225b. Additionally, a power turbine stop valve 217 is fluidly coupled to the working fluid circuit 202 between the inlet 225a and the power turbine 228. The power turbine stop valve 217 is configured to control the working fluid flowing from the heat exchanger 120, through the inlet 225a, and into the power turbine 228 while in an opened position. Alternatively, the power turbine stop valve 217 may be configured to cease the flow of working fluid from entering into the power turbine 228 while in a closed position.

A power turbine attemperator valve 223 is fluidly coupled to the working fluid circuit 202 via an attemperator bypass line 211 disposed between the outlet on the pump portion 262 of the turbopump 260 and the inlet on the power turbine 228 and/or disposed between the outlet on the pump portion 282 of the start pump 280 and the inlet on the power turbine 228. The attemperator bypass line 211 and the power turbine attemperator valve 223 may be configured to flow the working fluid from the pump portion 262 or 282, around and avoid the recuperator 216 and the heat exchangers 120 and 130, and to the power turbine 228, such as during a warm-up or cool-down step. The attemperator bypass line 211 and the power turbine attemperator valve 223 may be utilized to warm the working fluid with heat coming from the power turbine 228 while avoiding the thermal heat from the heat source stream 110 flowing through the heat exchangers, such as the heat exchangers 120 and 130. In some examples, the power turbine attemperator valve 223 may be fluidly coupled to the working fluid circuit 202 between the inlet 225b and the power turbine stop valve 217 upstream of a point on the fluid line that intersects the incoming stream from the inlet 225a. The power turbine attemperator valve 223 may be configured to control the working fluid flowing from the start pump 280 and/or the turbopump 260, through the inlet 225b, and to a power turbine stop valve 217, the power turbine bypass valve 219, and/or the power turbine 228.

The power turbine bypass valve 219 is fluidly coupled to a turbine bypass line that extends from a point of the working fluid circuit 202 upstream of the power turbine stop valve 217 and downstream from the power turbine 228. Therefore, the bypass line and the power turbine bypass valve 219 are configured to direct the working fluid around and avoid the power turbine 228. If the power turbine stop valve 217 is in a closed position, the power turbine bypass valve 219 may be configured to flow the working fluid around and avoid the power turbine 228 while in an opened position. In one embodiment, the power turbine bypass valve 219 may be utilized while warming up the working fluid during a startup operation of the electricity generating process. An outlet valve 221 is fluidly coupled to the working fluid circuit 202 between the outlet on the power turbine 228 and the outlet 227 of the power generation system 220.

Turning now to the process system 210, in one or more configurations, the process system 210 is disposed on or in the main process skid 212 and includes inlets 235, 239, and 255 and outlets 231, 237, 241, 251, and 253 fluidly coupled to and in thermal communication with the working fluid within the working fluid circuit 202. The inlet 235 is upstream of the recuperator 216 and the outlet 154 is downstream from the recuperator 216. The working fluid circuit 202 is configured to flow the working fluid from the inlet 235, through the recuperator 216, and to the outlet 237 while transferring thermal energy from the working fluid in the low pressure side of the working fluid circuit 202 to the working fluid in the high pressure side of the working fluid circuit 202 by the recuperator 216. The outlet 241 of the process system 210 is downstream from the turbopump 260 and/or the start pump 280, upstream of the power turbine 228, and configured to provide a flow of the high pressure working fluid to the power generation system 220, such as to the power turbine 228. The inlet 239 is upstream of the recuperator 216, downstream from the power turbine 228, and configured to receive the low pressure working fluid flowing from the power generation system 220, such as to the power turbine 228. The outlet 251 of the process system 210 is downstream from the recuperator 218, upstream of the heat exchanger 150, and configured to provide a flow of working fluid to the heat exchanger 150. The inlet 255 is downstream from the heat exchanger 150, upstream of the drive turbine 264 of the turbopump 260, and configured to provide the heated high pressure working fluid flowing from the heat exchanger 150 to the drive turbine 264 of the turbopump 260. The outlet 253 of the process system 210 is downstream from the pump portion 262 of the turbopump 260 and/or the pump portion 282 of the start pump 280, couples a bypass line disposed downstream from the heat exchanger 150 and upstream of the drive turbine 264 of the turbopump 260, and is configured to provide a flow of working fluid to the drive turbine 264 of the turbopump 260.

Additionally, a filter 215c may be disposed along and in fluid communication with the fluid line at a point downstream from the heat exchanger 150 and upstream of the drive turbine 264 of the turbopump 260. In some examples, the filter 215c is fluidly coupled to the working fluid circuit 202 between the outlet 154 of the waste heat system 100 and the inlet 255 of the process system 210. Further, a filter 215b may be disposed along and in fluid communication with the fluid line 135 at a point downstream from the heat exchanger 130 and upstream of the recuperator 216. In some examples, the filter 215b is fluidly coupled to the working fluid circuit 202 between the outlet 134 of the waste heat system 100 and the inlet 235 of the process system 210.

In certain embodiments, as illustrated in FIG. 1, the process system 210 may be disposed on or in the main process skid 212, the power generation system 220 may be disposed on or in a power generation skid 222, and the waste heat system 100 may be disposed on or in a waste heat skid 102. In these embodiments, the working fluid circuit 202 extends throughout the inside, the outside, and between the main process skid 212, the power generation skid 222, and the waste heat skid 102, as well as other systems and portions of the heat engine system 200. Further, in some embodiments, the heat engine system 200 includes the heat exchanger bypass line 160 and the heat exchanger bypass valve 162 disposed between the waste heat skid 102 and the main process skid 212 for the purpose of routing the working fluid away from one or more of the heat exchangers during startup to reduce or eliminate component wear and/or damage.

Turning now to features of the working fluid circuit 202, the working fluid circuit 202 contains the working fluid (e.g., sc-CO₂) and has a high pressure side and a low pressure side. FIG. 1 depicts the high and low pressure sides of the working fluid circuit 202 of the heat engine system 200 by representing the high pressure side with “ [symbol] ” and the low pressure side with “ [symbol] ”—as described in one or more embodiments. In certain embodiments, the working fluid circuit 202 includes one or more pumps, such as the illustrated turbopump 260 and start pump 280. The turbopump 260 and the start pump 280 are operative to pressurize and circulate the working fluid throughout the working fluid circuit 202 and may each be an assembly of components that form the turbopump 260 or the start pump 280.

The turbopump 260 may be a turbo-drive pump or a turbine-drive pump and, in some embodiments, may form a pump assembly having a pump portion 262 and a drive turbine 264 coupled together by a driveshaft 267 and an optional gearbox (not shown). The driveshaft 267 may be a single shaft or may contain two or more shafts coupled together. In one example, a first segment of the driveshaft 267 extends from the drive turbine 264 to the gearbox, a second segment of the driveshaft 230 extends from the gearbox to the pump portion 262, and multiple gears are disposed between and couple to the two segments of the driveshaft 267 within the gearbox.

The drive turbine 264 is configured to rotate the pump portion 262, and the pump portion 262 is configured to circulate the working fluid within the working fluid circuit 202. Accordingly, the pump portion 262 of the turbopump 260 may be disposed between the high pressure side and the low pressure side of the working fluid circuit 202. The pump inlet on the pump portion 262 is generally disposed in the low pressure side and the pump outlet on the pump portion 262 is generally disposed in the high pressure side. The drive turbine 264 of the turbopump 260 may be fluidly coupled to the working fluid circuit 202 downstream from the heat exchanger 150, and the pump portion 262 of the turbopump 260 is fluidly coupled to the working fluid circuit 202 upstream of the heat exchanger 120 for providing the heated working fluid to the turbopump 260 to move or otherwise power the drive turbine 264.

The start pump 280 has a pump portion 282 and a motor-drive portion 284. The start pump 280 is generally an electric motorized pump or a mechanical motorized pump, and may be a variable frequency driven pump. During operation, once a predetermined pressure, temperature, and/or flowrate of the working fluid is obtained within the working fluid circuit 202, the start pump 280 may be taken offline, idled, or turned off, and the turbopump 260 may be utilized to circulate the working fluid during the electricity generation process. The working fluid enters each of the turbopump 260 and the start pump 280 from the low pressure side of the working fluid circuit 202 and exits each of the turbopump 260 and the start pump 280 from the high pressure side of the working fluid circuit 202.

The start pump 280 may be a motorized pump, such as an electric motorized pump, a mechanical motorized pump, or other type of pump. Generally, the start pump 280 may be a variable frequency motorized drive pump and contains a pump portion 282 and a motor-drive portion 284. The motor-drive portion 284 of the start pump 280 contains a motor and a drive including a driveshaft and gears. In some examples, the motor-drive portion 284 has a variable frequency drive, such that the speed of the motor may be regulated by the drive. The pump portion 282 of the start pump 280 is driven by the motor-drive portion 284 coupled thereto. The pump portion 282 has an inlet for receiving the working fluid from the low pressure side of the working fluid circuit 202, such as from the condenser 274 and/or the working fluid storage system 290. The pump portion 282 has an outlet for releasing the working fluid into the high pressure side of the working fluid circuit 202.

Start pump inlet valve 283 and start pump outlet valve 285 may be utilized to control the flow of the working fluid passing through the start pump 280. Start pump inlet valve 283 may be fluidly coupled to the low pressure side of the working fluid circuit 202 upstream of the pump portion 282 of the start pump 280 and may be utilized to control the flowrate of the working fluid entering the inlet of the pump portion 282. Start pump outlet valve 285 may be fluidly coupled to the high pressure side of the working fluid circuit 202 downstream from the pump portion 282 of the start pump 280 and may be utilized to control the flowrate of the working fluid exiting the outlet of the pump portion 282.

The drive turbine 264 of the turbopump 260 is driven by heated working fluid, such as the working fluid flowing from the heat exchanger 150. The drive turbine 264 is fluidly coupled to the high pressure side of the working fluid circuit 202 by an inlet configured to receive the working fluid from the high pressure side of the working fluid circuit 202, such as flowing from the heat exchanger 150. The drive turbine 264 is fluidly coupled to the low pressure side of the working fluid circuit 202 by an outlet configured to release the working fluid into the low pressure side of the working fluid circuit 202.

The pump portion 262 of the turbopump 260 is driven by the driveshaft 267 coupled to the drive turbine 264. The pump portion 262 of the turbopump 260 may be fluidly coupled to the low pressure side of the working fluid circuit 202 by an inlet configured to receive the working fluid from the low pressure side of the working fluid circuit 202. The inlet of the pump portion 262 is configured to receive the working fluid from the low pressure side of the working fluid circuit 202, such as from the condenser 274 and/or the working fluid storage system 290. Also, the pump portion 262 may be fluidly coupled to the high pressure side of the working fluid circuit 202 by an outlet configured to release the working fluid into the high pressure side of the working fluid circuit 202 and circulate the working fluid within the working fluid circuit 202.

In one configuration, the working fluid released from the outlet on the drive turbine 264 is returned into the working fluid circuit 202 downstream from the recuperator 216 and upstream of the recuperator 218. In one or more embodiments, the turbopump 260, including piping and valves, is optionally disposed on a turbo pump skid 266, as depicted in FIG. 1. The turbo pump skid 266 may be disposed on or adjacent to the main process skid 212.

A drive turbine bypass valve 265 is generally coupled between and in fluid communication with a fluid line extending from the inlet on the drive turbine 264 with a fluid line extending from the outlet on the drive turbine 264. The drive turbine bypass valve 265 is generally opened to bypass the turbopump 260 while using the start pump 280 during the initial stages of generating electricity with the heat engine system 200. Once a predetermined pressure and temperature of the working fluid is obtained within the working fluid circuit 202, the drive turbine bypass valve 265 is closed and the heated working fluid is flowed through the drive turbine 264 to start the turbopump 260.

A drive turbine throttle valve 263 may be coupled between and in fluid communication with a fluid line extending from the heat exchanger 150 to the inlet on the drive turbine 264 of the turbopump 260. The drive turbine throttle valve 263 is configured to modulate the flow of the heated working fluid into the drive turbine 264, which in turn may be utilized to adjust the flow of the working fluid throughout the working fluid circuit 202. Additionally, valve 293 may be utilized to provide back pressure for the drive turbine 264 of the turbopump 260.

A drive turbine attemperator valve 295 may be fluidly coupled to the working fluid circuit 202 via an attemperator bypass line 291 disposed between the outlet on the pump portion 262 of the turbopump 260 and the inlet on the drive turbine 264 and/or disposed between the outlet on the pump portion 282 of the start pump 280 and the inlet on the drive turbine 264. The attemperator bypass line 291 and the drive turbine attemperator valve 295 may be configured to flow the working fluid from the pump portion 262 or 282, around the recuperator 218 and the heat exchanger 150 to avoid such components, and to the drive turbine 264, such as during a warm-up or cool-down step of the turbopump 260. The attemperator bypass line 291 and the drive turbine attemperator valve 295 may be utilized to warm the working fluid with the drive turbine 264 while avoiding the thermal heat from the heat source stream 110 via the heat exchangers, such as the heat exchanger 150.

In another embodiment, the heat engine system 200 depicted in FIG. 1 has two pairs of turbine attemperator lines and valves, such that each pair of attemperator line and valve is fluidly coupled to the working fluid circuit 202 and disposed upstream of a respective turbine inlet, such as a drive turbine inlet and a power turbine inlet. The power turbine attemperator line 211 and the power turbine attemperator valve 223 are fluidly coupled to the working fluid circuit 202 and disposed upstream of a turbine inlet on the power turbine 264. Similarly, the drive turbine attemperator line 291 and the drive turbine attemperator valve 295 are fluidly coupled to the working fluid circuit 202 and disposed upstream of a turbine inlet on the turbopump 260.

The power turbine attemperator valve 223 and the drive turbine attemperator valve 295 may be utilized during a startup and/or shutdown procedure of the heat engine system 200 to control backpressure within the working fluid circuit 202. Also, the power turbine attemperator valve 223 and the drive turbine attemperator valve 295 may be utilized during a startup and/or shutdown procedure of the heat engine system 200 to cool hot flow of the working fluid from heat saturated heat exchangers, such as heat exchangers 120, 130, and/or 150, coupled to and in thermal communication with working fluid circuit 202. The power turbine attemperator valve 223 may be modulated, adjusted, or otherwise controlled to manage the inlet temperature T₁ and/or the inlet pressure at (or upstream from) the inlet of the power turbine 228, and to cool the heated working fluid flowing from the outlet of the heat exchanger 120. Similarly, the drive turbine attemperator valve 295 may be modulated, adjusted, or otherwise controlled to manage the inlet temperature and/or the inlet pressure at (or upstream from) the inlet of the drive turbine 264, and to cool the heated working fluid flowing from the outlet of the heat exchanger 150.

In some embodiments, the drive turbine attemperator valve 295 may be modulated, adjusted, or otherwise controlled with the process control system 204 to decrease the inlet temperature of the drive turbine 264 by increasing the flowrate of the working fluid passing through the attemperator bypass line 291 and the drive turbine attemperator valve 295 and detecting a desirable value of the inlet temperature of the drive turbine 264 via the process control system 204. The desirable value is generally at or less than the predetermined threshold value of the inlet temperature of the drive turbine 264. In some examples, such as during startup of the turbopump 260, the desirable value for the inlet temperature upstream of the drive turbine 264 may be about 150° C. or less. In other examples, such as during an energy conversion process, the desirable value for the inlet temperature upstream of the drive turbine 264 may be about 170° C. or less, such as about 168° C. or less. The drive turbine 264 and/or components therein may be damaged if the inlet temperature is about 168° C. or greater.

In some embodiments, the working fluid may flow through the attemperator bypass line 291 and the drive turbine attemperator valve 295 to bypass the heat exchanger 150. This flow of the working fluid may be adjusted with throttle valve 263 to control the inlet temperature of the drive turbine 264. During the startup of the turbopump 260, the desirable value for the inlet temperature upstream of the drive turbine 264 may be about 150° C. or less. As power is increased, the inlet temperature upstream of the drive turbine 264 may be raised to optimize cycle efficiency and operability by reducing the flow through the attemperator bypass line 291. At full power, the inlet temperature upstream of the drive turbine 264 may be about 340° C. or greater and the flow of the working fluid bypassing the heat exchanger 150 through the attemperator bypass line 291 ceases, such as approaches about 0 kg/s, in some examples. Also, the pressure may range from about 14 MPa to about 23.4 MPa as the flow of the working fluid may be within a range from about 0 kg/s to about 32 kg/s depending on power level.

A control valve 261 may be disposed downstream from the outlet of the pump portion 262 of the turbopump 260 and the control valve 281 may be disposed downstream from the outlet of the pump portion 282 of the start pump 280. Control valves 261 and 281 are flow control safety valves and generally utilized to regulate the directional flow or to prohibit backflow of the working fluid within the working fluid circuit 202. Control valve 261 is configured to prevent the working fluid from flowing upstream towards or into the outlet of the pump portion 262 of the turbopump 260. Similarly, control valve 281 is configured to prevent the working fluid from flowing upstream towards or into the outlet of the pump portion 282 of the start pump 280.

The drive turbine throttle valve 263 is fluidly coupled to the working fluid circuit 202 upstream of the inlet of the drive turbine 264 of the turbopump 260 and configured to control a flow of the working fluid flowing into the drive turbine 264. The power turbine bypass valve 219 is fluidly coupled to the power turbine bypass line 208 and configured to modulate, adjust, or otherwise control the working fluid flowing through the power turbine bypass line 208 for controlling the flowrate of the working fluid entering the power turbine 228.

The power turbine bypass line 208 is fluidly coupled to the working fluid circuit 202 at a point upstream of an inlet of the power turbine 228 and at a point downstream from an outlet of the power turbine 228. The power turbine bypass line 208 is configured to flow the working fluid around and avoid the power turbine 228 when the power turbine bypass valve 219 is in an opened position. The flowrate and the pressure of the working fluid flowing into the power turbine 228 may be reduced or stopped by adjusting the power turbine bypass valve 219 to the opened position. Alternatively, the flowrate and the pressure of the working fluid flowing into the power turbine 228 may be increased or started by adjusting the power turbine bypass valve 219 to the closed position due to the backpressure formed through the power turbine bypass line 208.

The power turbine bypass valve 219 and the drive turbine throttle valve 263 may be independently controlled by the process control system 204 that is communicably connected, wired and/or wirelessly, with the power turbine bypass valve 219, the drive turbine throttle valve 263, and other parts of the heat engine system 200. The process control system 204 is operatively connected to the working fluid circuit 202 and a mass management system 270 and is enabled to monitor and control multiple process operation parameters of the heat engine system 200.

In one or more embodiments, the working fluid circuit 202 provides a bypass flowpath for the start pump 280 via the start pump bypass line 224 and a start pump bypass valve 254, as well as a bypass flowpath for the turbopump 260 via the turbo pump bypass line 226 and a turbo pump bypass valve 256. One end of the start pump bypass line 224 is fluidly coupled to an outlet of the pump portion 282 of the start pump 280, and the other end of the start pump bypass line 224 is fluidly coupled to a fluid line 229. Similarly, one end of a turbo pump bypass line 226 is fluidly coupled to an outlet of the pump portion 262 of the turbopump 260 and the other end of the turbo pump bypass line 226 is coupled to the start pump bypass line 224. In some configurations, the start pump bypass line 224 and the turbo pump bypass line 226 merge together as a single line upstream of coupling to a fluid line 229. The fluid line 229 extends between and is fluidly coupled to the recuperator 218 and the condenser 274. The start pump bypass valve 254 is disposed along the start pump bypass line 224 and fluidly coupled between the low pressure side and the high pressure side of the working fluid circuit 202 when in a closed position. Similarly, the turbo pump bypass valve 256 is disposed along the turbo pump bypass line 226 and fluidly coupled between the low pressure side and the high pressure side of the working fluid circuit 202 when in a closed position.

FIG. 1 further depicts a power turbine throttle valve 250 fluidly coupled to a bypass line 246 on the high pressure side of the working fluid circuit 202 and upstream of the heat exchanger 120, as disclosed by at least one embodiment described herein. The power turbine throttle valve 250 is fluidly coupled to the bypass line 246 and configured to modulate, adjust, or otherwise control the working fluid flowing through the bypass line 246 for controlling a general coarse flowrate of the working fluid within the working fluid circuit 202. The bypass line 246 is fluidly coupled to the working fluid circuit 202 at a point upstream of the valve 293 and at a point downstream from the pump portion 282 of the start pump 280 and/or the pump portion 262 of the turbopump 260.

Additionally, a power turbine trim valve 252 is fluidly coupled to a bypass line 248 on the high pressure side of the working fluid circuit 202 and upstream of the heat exchanger 150, as disclosed by another embodiment described herein. The power turbine trim valve 252 is fluidly coupled to the bypass line 248 and configured to modulate, adjust, or otherwise control the working fluid flowing through the bypass line 248 for controlling a fine flowrate of the working fluid within the working fluid circuit 202. The bypass line 248 is fluidly coupled to the bypass line 246 at a point upstream of the power turbine throttle valve 250 and at a point downstream from the power turbine throttle valve 250.

The heat engine system 200 further contains a drive turbine throttle valve 263 fluidly coupled to the working fluid circuit 202 upstream of the inlet of the drive turbine 264 of the turbopump 260 and configured to modulate a flow of the working fluid flowing into the drive turbine 264, a power turbine bypass line 208 fluidly coupled to the working fluid circuit 202 upstream of an inlet of the power turbine 228, fluidly coupled to the working fluid circuit 202 downstream from an outlet of the power turbine 228, and configured to flow the working fluid around and avoid the power turbine 228, a power turbine bypass valve 219 fluidly coupled to the power turbine bypass line 208 and configured to modulate a flow of the working fluid flowing through the power turbine bypass line 208 for controlling the flowrate of the working fluid entering the power turbine 228, and the process control system 204 operatively connected to the heat engine system 200, wherein the process control system 204 is configured to adjust the drive turbine throttle valve 263 and the power turbine bypass valve 219.

A heat exchanger bypass line 160 is fluidly coupled to a fluid line 131 of the working fluid circuit 202 upstream of the heat exchangers 120, 130, and/or 150 by a heat exchanger bypass valve 162, as illustrated in FIG. 1 and described in more detail below. The heat exchanger bypass valve 162 may be a solenoid valve, a hydraulic valve, an electric valve, a manual valve, or derivatives thereof. In many examples, the heat exchanger bypass valve 162 is a solenoid valve and configured to be controlled by the process control system 204. Regardless of the valve type, however, the valve may be controlled to route the working fluid in a manner that maintains the temperature of the working fluid at a level appropriate for the current operational state of the heat engine system. For example, the bypass valve may be regulated during startup to control the flow of the working fluid through a reduced quantity of heat exchangers to effectuate a lower working fluid temperature than would be achieved during a fully operational state when the working fluid is routed through all the heat exchangers.

In one or more embodiments, the working fluid circuit 202 provides release valves 213a, 213b, 213c, and 213d, as well as release outlets 214a, 214b, 214c, and 214d, respectively in fluid communication with each other. Generally, the release valves 213a, 213b, 213c, and 213d remain closed during the electricity generation process, but may be configured to automatically open to release an over-pressure at a predetermined value within the working fluid. Once the working fluid flows through the valve 213a, 213b, 213c, or 213d, the working fluid is vented through the respective release outlet 214a, 214b, 214c, or 214d. The release outlets 214a, 214b, 214c, and 214d may provide passage of the working fluid into the ambient surrounding atmosphere. Alternatively, the release outlets 214a, 214b, 214c, and 214d may provide passage of the working fluid into a recycling or reclamation step that generally includes capturing, condensing, and storing the working fluid.

The release valve 213a and the release outlet 214a are fluidly coupled to the working fluid circuit 202 at a point disposed between the heat exchanger 120 and the power turbine 228. The release valve 213b and the release outlet 214b are fluidly coupled to the working fluid circuit 202 at a point disposed between the heat exchanger 150 and the drive turbine 264 of the turbopump 260. The release valve 213c and the release outlet 214c are fluidly coupled to the working fluid circuit 202 via a bypass line that extends from a point between the valve 293 and the pump portion 262 of the turbopump 260 to a point on the turbo pump bypass line 226 between the turbo pump bypass valve 256 and the fluid line 229. The release valve 213d and the release outlet 214d are fluidly coupled to the working fluid circuit 202 at a point disposed between the recuperator 218 and the condenser 274.

A computer system 206, as part of the process control system 204, contains a multi-controller algorithm utilized to control the drive turbine throttle valve 263, the power turbine bypass valve 219, the heat exchanger bypass valve 162, the power turbine throttle valve 250, and the power turbine trim valve 252, as well as other valves, pumps, and sensors within the heat engine system 200. Further, in some embodiments, the process control system 204 is communicably connected, wired and/or wirelessly, with numerous sets of sensors, valves, and pumps, in order to process the measured and reported temperatures, pressures, and mass flowrates of the working fluid at the designated points within the working fluid circuit 202. In response to these measured and/or reported parameters, the process control system 204 may be operable to selectively adjust the valves in accordance with a control program or algorithm, thereby maximizing operation of the heat engine system 200.

Further, in certain embodiments, the process control system 204, as well as any other controllers or processors disclosed herein, may include one or more non-transitory, tangible, machine-readable media, such as read-only memory (ROM), random access memory (RAM), solid state memory (e.g., flash memory), floppy diskettes, CD-ROMs, hard drives, universal serial bus (USB) drives, any other computer readable storage medium, or any combination thereof. The storage media may store encoded instructions, such as firmware, that may be executed by the process control system 204 to operate the logic or portions of the logic presented in the methods disclosed herein. For example, in certain embodiments, the heat engine system 200 may include computer code disposed on a computer-readable storage medium or a process controller that includes such a computer-readable storage medium.

In some embodiments, the process control system 204 contains a control algorithm embedded in a computer system 206, which may include one or more control circuits, and the control algorithm contains a governing loop controller. The governing loop controller is generally utilized to adjust values throughout the working fluid circuit 202 for controlling the temperature, pressure, flowrate, and/or mass of the working fluid at specified points therein. In some embodiments, the governing loop controller may be configured to maintain desirable threshold values for the inlet temperature and the inlet pressure by modulating, adjusting, or otherwise controlling the drive turbine attemperator valve 295 and the drive turbine throttle valve 263. In other embodiments, the governing loop controller may be configured to maintain desirable threshold values for the inlet temperature by modulating, adjusting, or otherwise controlling the power turbine attemperator valve 223 and the power turbine throttle valve 250.

The process control system 204 may operate with the heat engine system 200 semi-passively with the aid of several sets of sensors. The first set of sensors may be arranged at or adjacent the suction inlet of the turbopump 260 and the start pump 280, and the second set of sensors may be arranged at or adjacent the outlet of the turbopump 260 and the start pump 280. The first and second sets of sensors monitor and report the pressure, temperature, mass flowrate, or other properties of the working fluid within the low and high pressure sides of the working fluid circuit 202 adjacent the turbopump 260 and the start pump 280. The third set of sensors may be arranged either inside or adjacent the working fluid storage vessel 292 of the working fluid storage system 290 to measure and report the pressure, temperature, mass flowrate, or other properties of the working fluid within the working fluid storage vessel 292. Additionally, an instrument air supply (not shown) may be coupled to sensors, devices, or other instruments within the heat engine system 200 including the mass management system 270 and/or other system components that may utilize a gaseous supply, such as nitrogen or air.

In some embodiments, the overall efficiency of the heat engine system 200 and the amount of power ultimately generated can be influenced by the inlet or suction pressure at the pump when the working fluid contains supercritical carbon dioxide. In order to minimize or otherwise regulate the suction pressure of the pump, the heat engine system 200 may incorporate the use of a mass management system (“MMS”) 270. The mass management system 270 controls the inlet pressure of the start pump 280 by regulating the amount of working fluid entering and/or exiting the heat engine system 200 at strategic locations in the working fluid circuit 202, such as at tie-in points, inlets/outlets, valves, or conduits throughout the heat engine system 200. Consequently, the heat engine system 200 becomes more efficient by increasing the pressure ratio for the start pump 280 to a maximum possible extent.

The mass management system 270 contains at least one vessel or tank, such as a storage vessel (e.g., working fluid storage vessel 292), a fill vessel, and/or a mass control tank (e.g., mass control tank 286), fluidly coupled to the low pressure side of the working fluid circuit 202 via one or more valves, such as valve 287. The valves are moveable—as being partially opened, fully opened, and/or closed—to either remove working fluid from the working fluid circuit 202 or add working fluid to the working fluid circuit 202. Exemplary embodiments of the mass management system 270, and a range of variations thereof, are found in U.S. application Ser. No. 13/278,705, filed Oct. 21, 2011, published as U.S. Pub. No. 2012-0047892, and issued as U.S. Pat. No. 8,613,195, the contents of which are incorporated herein by reference to the extent consistent with the present disclosure. Briefly, however, the mass management system 270 may include a plurality of valves and/or connection points, each in fluid communication with the mass control tank 286. The valves may be characterized as termination points where the mass management system 270 is operatively connected to the heat engine system 200. The connection points and valves may be configured to provide the mass management system 270 with an outlet for flaring excess working fluid or pressure, or to provide the mass management system 270 with additional/supplemental working fluid from an external source, such as a fluid fill system.

In some embodiments, the mass control tank 286 may be configured as a localized storage tank for additional/supplemental working fluid that may be added to the heat engine system 200 when needed in order to regulate the pressure or temperature of the working fluid within the working fluid circuit 202 or otherwise supplement escaped working fluid. By controlling the valves, the mass management system 270 adds and/or removes working fluid mass to/from the heat engine system 200 with or without the need of a pump, thereby reducing system cost, complexity, and maintenance.

In some examples, a working fluid storage vessel 292 is part of a working fluid storage system 290 and is fluidly coupled to the working fluid circuit 202. At least one connection point, such as a working fluid feed 288, may be a fluid fill port for the working fluid storage vessel 292 of the working fluid storage system 290 and/or the mass management system 270. Additional or supplemental working fluid may be added to the mass management system 270 from an external source, such as a fluid fill system via the working fluid feed 288. Exemplary fluid fill systems are described and illustrated in U.S. Pat. No. 8,281,593, the contents of which are incorporated herein by reference to the extent consistent with the present disclosure.

In another embodiment described herein, bearing gas and seal gas may be supplied to the turbopump 260 or other devices contained within and/or utilized along with the heat engine system 200. One or multiple streams of bearing gas and/or seal gas may be derived from the working fluid within the working fluid circuit 202 and contain carbon dioxide in a gaseous, subcritical, or supercritical state.

In some examples, the bearing gas or fluid is flowed by the start pump 280, from a bearing gas supply 296a and/or a bearing gas supply 296b, into the working fluid circuit 202, through a bearing gas supply line (not shown), and to the bearings within the power generation system 220. In other examples, the bearing gas or fluid is flowed by the start pump 280, from the bearing gas supply 296a and/or the bearing gas supply 296b, from the working fluid circuit 202, through a bearing gas supply line (not shown), and to the bearings within the turbopump 260. The gas return 298 may be a connection point or valve that feeds into a gas system, such as a bearing gas, dry gas, seal gas, or other system.

At least one gas return 294 is generally coupled to a discharge, recapture, or return of bearing gas, seal gas, and other gases. The gas return 294 provides a feed stream into the working fluid circuit 202 of recycled, recaptured, or otherwise returned gases—generally derived from the working fluid. The gas return 294 is generally fluidly coupled to the working fluid circuit 202 upstream of the condenser 274 and downstream from the recuperator 218.

In another embodiment, the bearing gas supply source 141 is fluidly coupled to the bearing housing 268 of the turbopump 260 by the bearing gas supply line 142. The flow of the bearing gas or other gas into the bearing housing 268 may be controlled via the bearing gas supply valve 144 that is operatively coupled to the bearing gas supply line 142 and controlled by the process control system 204. The bearing gas or other gas generally flows from the bearing gas supply source 141, through the bearing housing 268 of the turbopump 260, and to the bearing gas recapture 148. The bearing gas recapture 148 is fluidly coupled to the bearing housing 268 by the bearing gas recapture line 146. The flow of the bearing gas or other gas from the bearing housing 268 and to bearing gas recapture 148 may be controlled via the bearing gas recapture valve 147 that is operatively coupled to the bearing gas recapture line 146 and controlled by the process control system 204.

In one or more embodiments, a working fluid storage vessel 292 may be fluidly coupled to the start pump 280 via the working fluid circuit 202 within the heat engine system 200. The working fluid storage vessel 292 and the working fluid circuit 202 contain the working fluid (e.g., carbon dioxide) and the working fluid circuit 202 fluidly has a high pressure side and a low pressure side.

The heat engine system 200 further contains a bearing housing, case, or other chamber, such as the bearing housings 238 and 268, fluidly coupled to and/or substantially encompassing or enclosing bearings within power generation system 220 and the turbine pump 260, respectively. In one embodiment, the turbopump 260 contains the drive turbine 264, the pump portion 262, and the bearing housing 268 fluidly coupled to and/or substantially encompassing or enclosing the bearings. The turbopump 260 further may contain a gearbox and/or a driveshaft 267 coupled between the drive turbine 264 and the pump portion 262. In another embodiment, the power generation system 220 contains the power turbine 228, the power generator 240, and the bearing housing 238 substantially encompassing or enclosing the bearings. The power generation system 220 further contains a gearbox 232 and a driveshaft 230 coupled between the power turbine 228 and the power generator 240.

Exemplary structures of the bearing housing 238 or 268 may completely or substantially encompass or enclose the bearings as well as all or part of turbines, generators, pumps, driveshafts, gearboxes, or other components shown or not shown for heat engine system 200. The bearing housing 238 or 268 may completely or partially include structures, chambers, cases, housings, such as turbine housings, generator housings, driveshaft housings, driveshafts that contain bearings, gearbox housings, derivatives thereof, or combinations thereof. FIG. 1 depicts the bearing housing 268 fluidly coupled to and/or containing all or a portion of the drive turbine 264, the pump portion 262, and the driveshaft 267 of the turbopump 260. In other examples, the housing of the drive turbine 264 and the housing of the pump portion 262 may be independently coupled to and/or form portions of the bearing housing 268. Similarly, the bearing housing 238 may be fluidly coupled to and/or contain all or a portion of the power turbine 228, the power generator 240, the driveshaft 230, and the gearbox 232 of the power generation system 220. In some examples, the housing of the power turbine 228 is coupled to and/or forms a portion of the bearing housing 238.

In some embodiments, the heat engine system 200 also includes a leak recapture system 181 that may include a leak recapture line 182, a cooler, such as the condenser 272, a leak recapture compressor 180, a leak recapture storage vessel 184, and/or combinations thereof. The leak recapture line 182 may be fluidly coupled to and disposed between the leak recapture storage vessel 184 and the bearing housing 268. Similarly, the leak recapture compressor 180 and/or the condenser 272 may be fluidly coupled to the leak recapture line 182 and disposed between the leak recapture storage vessel 184 and the bearing housing 268.

During operation, the leak recapture system 181 receives a leaked fluid 336 from the bearing housing 268 and processes the leaked fluid 336 for recirculation in the working fluid circuit 202. To that end, the condenser 272 may be utilized to condense the leaked fluid 336, and the leak recapture compressor 180 may be utilized to compress the leaked fluid 336 before the leaked fluid 336 flows into the leak recapture storage vessel 184. Once recaptured in the leak recapture storage vessel 184, the leaked fluid 336 may be reintroduced into the working fluid circuit 202. In this way, residual leakage from a rotating shaft seal in the turbopump 260 may be captured, compressed, and recycled instead of being leaked to the surrounding environment.

In the illustrated embodiment, the leaked fluid 336 is shown being recycled to a location proximate the inlet of the condenser 274. However, it should be noted that in other embodiments, the leaked fluid 336 could be recycled to a variety of suitable locations. For example, in other embodiments, the leaked fluid 336 may be recycled to the bearing gas supply 296a or to the power turbine 228.

In one or more embodiments disclosed herein, the heat engine system 200 depicted in FIG. 1 is configured to monitor and maintain the working fluid within the low pressure side of the working fluid circuit 202 in a supercritical state during a startup procedure. The working fluid may be maintained in a supercritical state by adjusting or otherwise controlling a pump suction pressure upstream of an inlet on the pump portion 262 of the turbopump 260 via the process control system 204 operatively connected to the working fluid circuit 202.

The process control system 204 may be utilized to maintain, adjust, or otherwise control the pump suction pressure at or greater than the critical pressure of the working fluid during the startup procedure. The working fluid may be kept in a liquid-type or supercritical state and free or substantially free the gaseous state within the low pressure side of the working fluid circuit 202. Therefore, the pump system, including the turbopump 260 and/or the start pump 280, may avoid pump cavitation within the respective pump portions 262 and 282.

In some embodiments, the types of working fluid that may be circulated, flowed, or otherwise utilized in the working fluid circuit 202 of the heat engine system 200 include carbon oxides, hydrocarbons, alcohols, ketones, halogenated hydrocarbons, ammonia, amines, aqueous, or combinations thereof. Exemplary working fluids used in the heat engine system 200 include carbon dioxide, ammonia, methane, ethane, propane, butane, ethylene, propylene, butylene, acetylene, methanol, ethanol, acetone, methyl ethyl ketone, water, derivatives thereof, or mixtures thereof. Halogenated hydrocarbons may include hydrochlorofluorocarbons (HCFCs), hydrofluorocarbons (HFCs) (e.g., 1,1,1,3,3-pentafluoropropane (R245fa)), fluorocarbons, derivatives thereof, or mixtures thereof.

In many embodiments described herein, the working fluid circulated, flowed, or otherwise utilized in the working fluid circuit 202 of the heat engine system 200, and the other exemplary circuits disclosed herein, may be or may contain carbon dioxide (CO₂) and mixtures containing carbon dioxide. Generally, at least a portion of the working fluid circuit 202 contains the working fluid in a supercritical state (e.g., sc-CO₂). Carbon dioxide utilized as the working fluid or contained in the working fluid for power generation cycles has many advantages over other compounds typically used as working fluids, since carbon dioxide has the properties of being non-toxic and non-flammable and is also easily available and relatively inexpensive. Due in part to a relatively high working pressure of carbon dioxide, a carbon dioxide system may be much more compact than systems using other working fluids. The high density and volumetric heat capacity of carbon dioxide with respect to other working fluids makes carbon dioxide more “energy dense” meaning that the size of all system components can be considerably reduced without losing performance. It should be noted that use of the terms carbon dioxide (CO₂), supercritical carbon dioxide (sc-CO₂), or subcritical carbon dioxide (sub-CO₂) is not intended to be limited to carbon dioxide of any particular type, source, purity, or grade. For example, industrial grade carbon dioxide may be contained in and/or used as the working fluid without departing from the scope of the disclosure.

In other exemplary embodiments, the working fluid in the working fluid circuit 202 may be a binary, ternary, or other working fluid blend. The working fluid blend or combination can be selected for the unique attributes possessed by the fluid combination within a heat recovery system, as described herein. For example, one such fluid combination includes a liquid absorbent and carbon dioxide mixture enabling the combined fluid to be pumped in a liquid state to high pressure with less energy input than required to compress carbon dioxide. In another exemplary embodiment, the working fluid may be a combination of supercritical carbon dioxide (sc-CO₂), subcritical carbon dioxide (sub-CO₂), and/or one or more other miscible fluids or chemical compounds. In yet other exemplary embodiments, the working fluid may be a combination of carbon dioxide and propane, or carbon dioxide and ammonia, without departing from the scope of the disclosure.

The working fluid circuit 202 generally has a high pressure side, a low pressure side, and a working fluid circulated within the working fluid circuit 202. The use of the term “working fluid” is not intended to limit the state or phase of matter of the working fluid. For instance, the working fluid or portions of the working fluid may be in a fluid phase, a gas phase, a supercritical state, a subcritical state, or any other phase or state at any one or more points within the heat engine system 200 or thermodynamic cycle. In one or more embodiments, the working fluid is in a supercritical state over certain portions of the working fluid circuit 202 of the heat engine system 200 (e.g., a high pressure side) and in a subcritical state over other portions of the working fluid circuit 202 of the heat engine system 200 (e.g., a low pressure side).

In other embodiments, the entire thermodynamic cycle may be operated such that the working fluid is maintained in either a supercritical or subcritical state throughout the entire working fluid circuit 202 of the heat engine system 200. During different stages of operation, the high and low pressure sides the working fluid circuit 202 for the heat engine system 200 may contain the working fluid in a supercritical and/or subcritical state. For example, the high and low pressure sides of the working fluid circuit 202 may both contain the working fluid in a supercritical state during the startup procedure. However, once the system is synchronizing, load ramping, and/or fully loaded, the high pressure side of the working fluid circuit 202 may keep the working fluid in a supercritical state while the low pressure side the working fluid circuit 202 may be adjusted to contain the working fluid in a subcritical state or other liquid-type state.

Generally, the high pressure side of the working fluid circuit 202 contains the working fluid (e.g., sc-CO₂) at a pressure of about 15 MPa or greater, such as about 17 MPa or greater or about 20 MPa or greater. In some examples, the high pressure side of the working fluid circuit 202 may have a pressure within a range from about 15 MPa to about 30 MPa, more narrowly within a range from about 16 MPa to about 26 MPa, more narrowly within a range from about 17 MPa to about 25 MPa, and more narrowly within a range from about 17 MPa to about 24 MPa, such as about 23.3 MPa. In other examples, the high pressure side of the working fluid circuit 202 may have a pressure within a range from about 20 MPa to about 30 MPa, more narrowly within a range from about 21 MPa to about 25 MPa, and more narrowly within a range from about 22 MPa to about 24 MPa, such as about 23 MPa.

The low pressure side of the working fluid circuit 202 contains the working fluid (e.g., CO₂ or sub-CO₂) at a pressure of less than 15 MPa, such as about 12 MPa or less, or about 10 MPa or less. In some examples, the low pressure side of the working fluid circuit 202 may have a pressure within a range from about 4 MPa to about 14 MPa, more narrowly within a range from about 6 MPa to about 13 MPa, more narrowly within a range from about 8 MPa to about 12 MPa, and more narrowly within a range from about 10 MPa to about 11 MPa, such as about 10.3 MPa. In other examples, the low pressure side of the working fluid circuit 202 may have a pressure within a range from about 2 MPa to about 10 MPa, more narrowly within a range from about 4 MPa to about 8 MPa, and more narrowly within a range from about 5 MPa to about 7 MPa, such as about 6 MPa.

In some examples, the high pressure side of the working fluid circuit 202 may have a pressure within a range from about 17 MPa to about 23.5 MPa, and more narrowly within a range from about 23 MPa to about 23.3 MPa, while the low pressure side of the working fluid circuit 202 may have a pressure within a range from about 8 MPa to about 11 MPa, and more narrowly within a range from about 10.3 MPa to about 11 MPa.

Referring generally to FIG. 1, the heat engine system 200 includes the power turbine 228 disposed between the high pressure side and the low pressure side of the working fluid circuit 202, disposed downstream from the heat exchanger 120, and fluidly coupled to and in thermal communication with the working fluid. The power turbine 228 is configured to convert a pressure drop in the working fluid to mechanical energy whereby the absorbed thermal energy of the working fluid is transformed to mechanical energy of the power turbine 228. Therefore, the power turbine 228 is an expansion device capable of transforming a pressurized fluid into mechanical energy, generally, transforming high temperature and pressure fluid into mechanical energy, such as rotating a shaft (e.g., the driveshaft 230).

The power turbine 228 may contain or be a turbine, a turbo, an expander, or another device for receiving and expanding the working fluid discharged from the heat exchanger 120. The power turbine 228 may have an axial construction or radial construction and may be a single-staged device or a multi-staged device. Exemplary turbine devices that may be utilized in power turbine 228 include an expansion device, a geroler, a gerotor, a valve, other types of positive displacement devices such as a pressure swing, a turbine, a turbo, or any other device capable of transforming a pressure or pressure/enthalpy drop in a working fluid into mechanical energy. A variety of expanding devices are capable of working within the inventive system and achieving different performance properties that may be utilized as the power turbine 228.

The power turbine 228 is generally coupled to the power generator 240 by the driveshaft 230. A gearbox 232 is generally disposed between the power turbine 228 and the power generator 240 and adjacent or encompassing the driveshaft 230. The driveshaft 230 may be a single piece or may contain two or more pieces coupled together. In one example, as depicted in FIG. 1, a first segment of the driveshaft 230 extends from the power turbine 228 to the gearbox 232, a second segment of the driveshaft 230 extends from the gearbox 232 to the power generator 240, and multiple gears are disposed between and couple to the two segments of the driveshaft 230 within the gearbox 232.

In some configurations, the heat engine system 200 also provides for the delivery of a portion of the working fluid, seal gas, bearing gas, air, or other gas into a chamber or housing, such as a housing 238 within the power generation system 220 for purposes of cooling one or more parts of the power turbine 228. In other configurations, the driveshaft 230 includes a seal assembly (not shown) designed to prevent or capture any working fluid leakage from the power turbine 228. Additionally, a working fluid recycle system may be implemented along with the seal assembly to recycle seal gas back into the working fluid circuit 202 of the heat engine system 200. For example, in one embodiment, the seal cartridge 303 may be provided as part of the power generation system 220, and the leaked fluid 336 that is recaptured may be recycled back into the working fluid circuit 202.

The power generator 240 may be a generator, an alternator (e.g., permanent magnet alternator), or other device for generating electrical energy, such as transforming mechanical energy from the driveshaft 230 and the power turbine 228 to electrical energy. A power outlet 242 may be electrically coupled to the power generator 240 and configured to transfer the generated electrical energy from the power generator 240 and to an electrical grid 244. The electrical grid 244 may be or include an electrical grid, an electrical bus (e.g., plant bus), power electronics, other electric circuits, or combinations thereof. The electrical grid 244 generally contains at least one alternating current bus, alternating current grid, alternating current circuit, or combinations thereof. In one example, the power generator 240 is a generator and is electrically and operably connected to the electrical grid 244 via the power outlet 242. In another example, the power generator 240 is an alternator and is electrically and operably connected to power electronics (not shown) via the power outlet 242. In another example, the power generator 240 is electrically connected to power electronics which are electrically connected to the power outlet 242.

The power electronics may be configured to convert the electrical power into desirable forms of electricity by modifying electrical properties, such as voltage, current, or frequency. The power electronics may include converters or rectifiers, inverters, transformers, regulators, controllers, switches, resisters, storage devices, and other power electronic components and devices. In other embodiments, the power generator 240 may contain, be coupled with, or be other types of load receiving equipment, such as other types of electrical generation equipment, rotating equipment, a gearbox (e.g., gearbox 232), or other device configured to modify or convert the shaft work created by the power turbine 228. In one embodiment, the power generator 240 is in fluid communication with a cooling loop having a radiator and a pump for circulating a cooling fluid, such as water, thermal oils, and/or other suitable refrigerants. The cooling loop may be configured to regulate the temperature of the power generator 240 and power electronics by circulating the cooling fluid to draw away generated heat.

The heat engine system 200 also provides for the delivery of a portion of the working fluid into a chamber or housing of the power turbine 228 for purposes of cooling one or more parts of the power turbine 228. In one embodiment, due to the potential need for dynamic pressure balancing within the power generator 240, the selection of the site within the heat engine system 200 from which to obtain a portion of the working fluid is critical because introduction of this portion of the working fluid into the power generator 240 should respect or not disturb the pressure balance and stability of the power generator 240 during operation. Therefore, the pressure of the working fluid delivered into the power generator 240 for purposes of cooling is the same or substantially the same as the pressure of the working fluid at an inlet of the power turbine 228. The working fluid is conditioned to be at a desired temperature and pressure prior to being introduced into the power turbine 228. A portion of the working fluid, such as the spent working fluid, exits the power turbine 228 at an outlet of the power turbine 228 and is directed to one or more heat exchangers or recuperators, such as recuperators 216 and 218. The recuperators 216 and 218 may be fluidly coupled to the working fluid circuit 202 in series with each other. The recuperators 216 and 218 are operative to transfer thermal energy between the high pressure side and the low pressure side of the working fluid circuit 202.

In one embodiment, the recuperator 216 is fluidly coupled to the low pressure side of the working fluid circuit 202, disposed downstream from a working fluid outlet on the power turbine 228, and disposed upstream of the recuperator 218 and/or the condenser 274. The recuperator 216 is configured to remove at least a portion of thermal energy from the working fluid discharged from the power turbine 228. In addition, the recuperator 216 is also fluidly coupled to the high pressure side of the working fluid circuit 202, disposed upstream of the heat exchanger 120 and/or a working fluid inlet on the power turbine 228, and disposed downstream from the heat exchanger 130. The recuperator 216 is configured to increase the amount of thermal energy in the working fluid prior to flowing into the heat exchanger 120 and/or the power turbine 228. Therefore, the recuperator 216 is operative to transfer thermal energy between the high pressure side and the low pressure side of the working fluid circuit 202. In some examples, the recuperator 216 may be a heat exchanger configured to cool the low pressurized working fluid discharged or downstream from the power turbine 228 while heating the high pressurized working fluid entering into or upstream of the heat exchanger 120 and/or the power turbine 228.

Similarly, in another embodiment, the recuperator 218 is fluidly coupled to the low pressure side of the working fluid circuit 202, disposed downstream from a working fluid outlet on the power turbine 228 and/or the recuperator 216, and disposed upstream of the condenser 274. The recuperator 218 is configured to remove at least a portion of thermal energy from the working fluid discharged from the power turbine 228 and/or the recuperator 216. In addition, the recuperator 218 is also fluidly coupled to the high pressure side of the working fluid circuit 202, disposed upstream of the heat exchanger 150 and/or a working fluid inlet on a drive turbine 264 of turbopump 260, and disposed downstream from a working fluid outlet on the pump portion 262 of turbopump 260. The recuperator 218 is configured to increase the amount of thermal energy in the working fluid prior to flowing into the heat exchanger 150 and/or the drive turbine 264. Therefore, the recuperator 218 is operative to transfer thermal energy between the high pressure side and the low pressure side of the working fluid circuit 202. In some examples, the recuperator 218 may be a heat exchanger configured to cool the low pressurized working fluid discharged or downstream from the power turbine 228 and/or the recuperator 216 while heating the high pressurized working fluid entering into or upstream of the heat exchanger 150 and/or the drive turbine 264.

A cooler or a condenser 274 may be fluidly coupled to and in thermal communication with the low pressure side of the working fluid circuit 202 and may be configured or operative to control a temperature of the working fluid in the low pressure side of the working fluid circuit 202. The condenser 274 may be disposed downstream from the recuperators 216 and 218 and upstream of the start pump 280 and the turbopump 260. The condenser 274 receives the cooled working fluid from the recuperator 218 and further cools and/or condenses the working fluid which may be recirculated throughout the working fluid circuit 202. In many examples, the condenser 274 is a cooler and may be configured to control a temperature of the working fluid in the low pressure side of the working fluid circuit 202 by transferring thermal energy from the working fluid in the low pressure side to a cooling loop or system outside of the working fluid circuit 202.

A cooling media or fluid is generally utilized in the cooling loop or system by the condenser 274 for cooling the working fluid and removing thermal energy outside of the working fluid circuit 202. The cooling media or fluid flows through, over, or around while in thermal communication with the condenser 274. Thermal energy in the working fluid is transferred to the cooling fluid via the condenser 274. Therefore, the cooling fluid is in thermal communication with the working fluid circuit 202, but not fluidly coupled to the working fluid circuit 202. The condenser 274 may be fluidly coupled to the working fluid circuit 202 and independently fluidly coupled to the cooling fluid. The cooling fluid may contain one or multiple compounds and may be in one or multiple states of matter. The cooling fluid may be a media or fluid in a gaseous state, a liquid state, a subcritical state, a supercritical state, a suspension, a solution, derivatives thereof, or combinations thereof.

In many examples, the condenser 274 is generally fluidly coupled to a cooling loop or system (not shown) that receives the cooling fluid from a cooling fluid return 278a and returns the warmed cooling fluid to the cooling loop or system via a cooling fluid supply 278b. The cooling fluid may be water, carbon dioxide, or other aqueous and/or organic fluids (e.g., alcohols and/or glycols), air or other gases, or various mixtures thereof that is maintained at a lower temperature than the temperature of the working fluid. In other examples, the cooling media or fluid contains air or another gas exposed to the condenser 274, such as an air steam blown by a motorized fan or blower. A filter 276 may be disposed along and in fluid communication with the cooling fluid line at a point downstream from the cooling fluid supply 278b and upstream of the condenser 274. In some examples, the filter 276 may be fluidly coupled to the cooling fluid line within the process system 210.

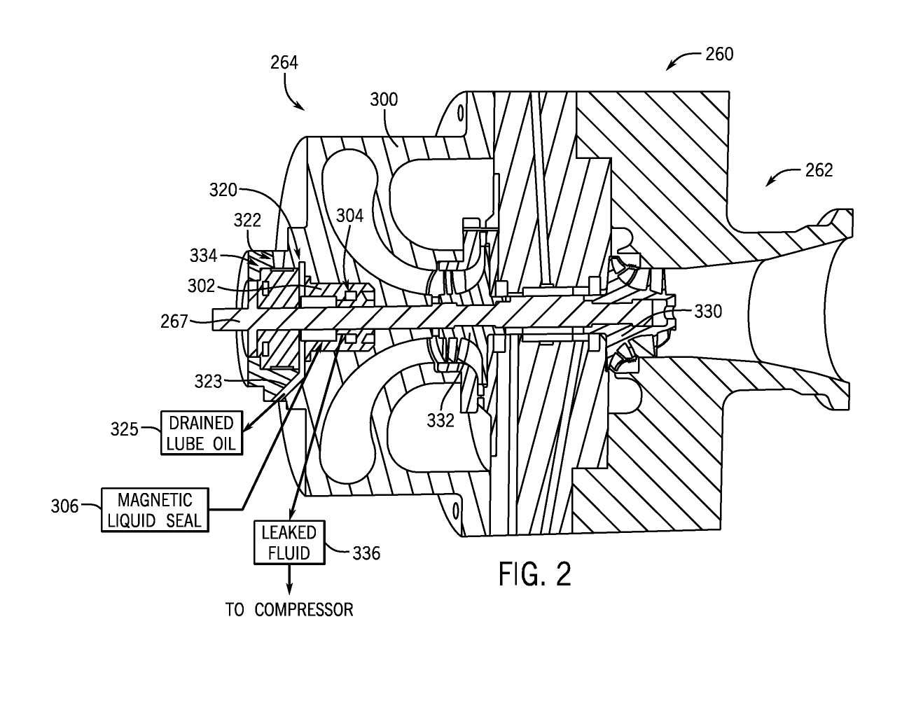

FIG. 2 illustrates a cross sectional view of an embodiment of the turbopump 260 including the pump portion 262 and the drive turbine 264 that are configured to be coupled via the driveshaft 267. In the illustrated embodiment, the turbopump 260 includes an outer housing 300 that encloses an impeller 330 of the pump portion 262, an impeller 332 of the drive turbine 264, an inner housing 302 of a seal cartridge 303, at least a portion of the driveshaft 267, a buffer gas chamber 320, and one or more portions of a lube oil system 334. The lube oil system 334 may include a lube oil supply 322 and a lube oil passageway 323 through which drained lube oil 325 may flow.

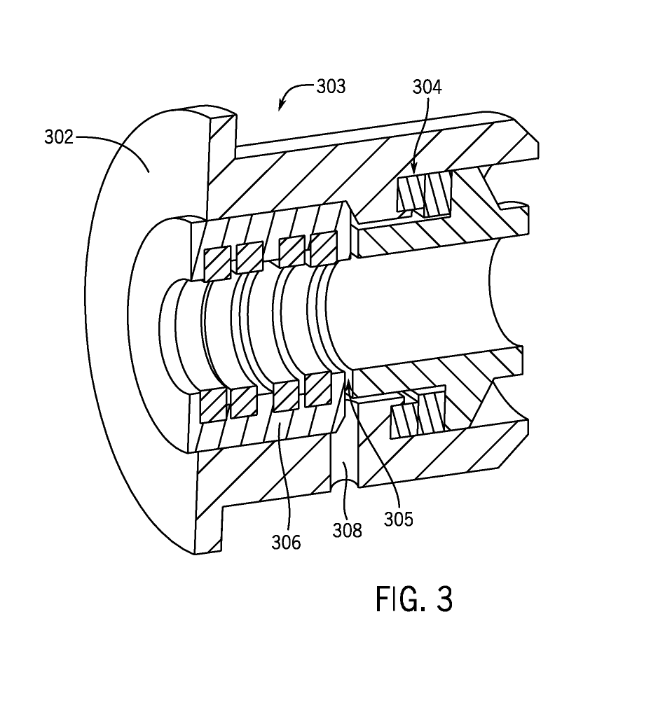

Further, as shown in more detail in FIG. 3, the inner housing 302 of the seal cartridge 303 defines a passageway for receiving the driveshaft 267 and may include a dry gas seal 304 circumferentially disposed about the driveshaft 267 between the driveshaft 267 and the inner housing 302 at a first axial location along the driveshaft 267 when the driveshaft 267 is received in the passageway. A magnetic liquid seal 306 may be circumferentially disposed about the driveshaft 267 between the driveshaft 267 and the inner housing 302 at a second axial location along the driveshaft 267 when the driveshaft 267 is received in the passageway. A fluid leakage cavity 305 may be formed between the dry gas seal 304 and the magnetic liquid seal 306, and an extraction port 308 may be disposed in the inner housing 302, the outer housing 300, or both to enable the leaked fluid 336 to be extracted from the fluid leakage cavity 305.

During operation, the drive turbine 264 may be powered by heated working fluid, for example, from a point downstream of the heat exchanger 150, and the impeller 332 of the drive turbine 264 rotates to generate power that drives the impeller 330 of the pump portion 262. The rotation of the impeller 330 of the pump portion 262 circulates the working fluid through the working fluid circuit 202. The lube oil supply 322 provides lube oil to one or more moving parts of the drive turbine 264. The lube oil provides lubrication before exiting the drive turbine 264 via the passageway 323, resulting in drained lube oil 325, which may be discarded or recycled, depending on the application.

The dry gas seal 304 may provide pressure isolation from a higher pressure adjacent the dry gas seal 304 (e.g., approximately 500 psi (about 3.45 MPa) to approximately 1,500 psi (about 10.34 MPa)) to a lower pressure (e.g., approximately atmospheric pressure to less than approximately 100 psi (about 689 kPa)) in a center portion of the dry gas seal 304. Further, the magnetic liquid seal 306 may isolate the fluid leakage cavity 305 from the surrounding environment and the lube oil system 334 to enable the leaked fluid 336 to be recaptured, compressed, and reused in the working fluid circuit 202. For example, the magnetic liquid seal 306 may isolate the leaked fluid 336 from the lube oil provided by the lube oil supply 322 to reduce or prevent the likelihood that the lube oil will mix with or contaminate the leaked fluid. Additionally, in some embodiments, a buffer gas may be injected into the buffer gas chamber 320 between the magnetic liquid seal 306 and the lube oil system 334 to further isolate the fluid leakage cavity 305 from the lube oil system 334.

In the illustrated embodiment, the dry gas seal 304 functions as the primary seal, and the magnetic liquid seal 306 functions as the secondary seal. However, it should be noted that in other embodiments, the dry gas seal 304 may be replaced with any other type of suitable primary seal, depending on implementation-specific considerations. For example, a tandem or opposed face dry gas seal, a labyrinth seal, a brush seal, or a combination thereof may function as the primary seal. However, in such embodiments, the magnetic liquid seal 306 may still function as the secondary seal, for example, as a replacement for a conventional segmented carbon seal. The magnetic liquid seal 306 may offer one or more advantages over the use of a segmented carbon seal by eliminating the consumption of buffer gas and the mixing of the buffer gas with the leaked fluid, which enables the leaked fluid to be recaptured and recycled in presently disclosed embodiments. Accordingly, the use of the magnetic liquid seal 306 may render the heat engine system 200 more efficient by reducing working fluid losses during operation.

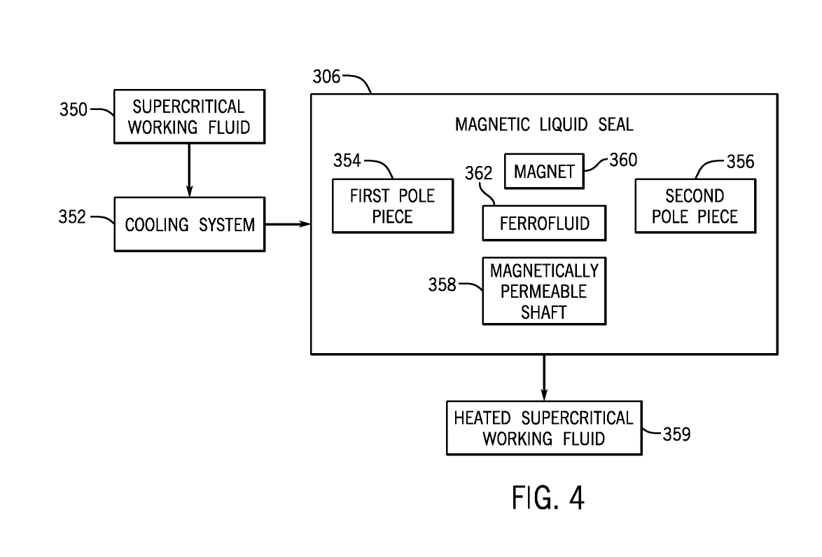

FIG. 4 is a schematic illustrating an embodiment of the magnetic liquid seal 306 and a cooling system 352 for cooling components of the magnetic liquid seal 306 with a supercritical working fluid 350. In one embodiment, the magnetic liquid seal 306 may be a Ferrofluidic seal manufactured by Ferrotec Corporation of Santa Clara, Calif. In the illustrated embodiment, the magnetic liquid seal 306 includes a first pole piece 354, a second pole piece 356, a magnetically permeable shaft 358 (which may be driveshaft 267 or may be a sleeve placed over driveshaft 267) and a magnet 360, which, when assembled, may collectively form a magnetic circuit capable of attracting and maintaining a ferrofluid 362 therein. For example, in one embodiment, the first pole piece 354, the second pole piece 356, and the magnet 360 may be formed as annular rings about the magnetically permeable shaft 358. The magnet 360 may be disposed between the first pole piece 354 and the second pole piece 356. Further, in some embodiments, a housing may enclose the first pole piece 354, the second pole piece 356, the magnet 360, the magnetically permeable shaft 358, and the ferrofluid 362 to form an assembly.

During operation, the magnet 360 applies a magnetic field that results in a magnetic flux concentrated in a radial gap between the magnetically permeable shaft 358 and the first and second pole pieces 354 and 356. The ferrofluid 362 is susceptible to the magnetic field and is drawn toward the magnet 360. When the ferrofluid 362 reaches the radial gap, the concentrated magnetic flux captures and maintains the ferrofluid 362 in the radial gap, thereby creating a ring-shaped seal. If a single stage of the ferrofluid 362 is utilized, a pressure differential of about 20 kPa may be sustained. However, in some embodiments, if larger pressure differentials are desired, multiple stages of the ferrofluid 362 may be formed in rings about the magnetically permeable shaft 358 such that the collective arrangement is capable of sustaining a higher overall pressure differential.

In presently disclosed embodiments, the ferrofluid 362 may be any fluid that becomes magnetized in the presence of a magnetic field. For example, in one embodiment, the ferrofluid 362 may be a colloidal suspension including ferromagnetic or ferrimagnetic nanoscale particles suspended in a carrier fluid. The carrier fluid may be any suitable solvent or water, and the nanoscale particles may be formed from any material responsive to an applied magnetic field. For example, the nanoscale particles may be formed from materials including but not limited to magnetite, hematite, iron, or a combination thereof. Further, in some embodiments, the nanoscale particles may be coated with a surfactant to reduce or eliminate the likelihood of agglomeration of the nanoscale particles. Additionally, in some embodiments, the nanoscale particles may have a diameter less than or equal to approximately 10 nanometers.

In the embodiment illustrated in FIG. 4, the cooling system 352 may be operated to cool one or more components of the magnetic liquid seal 306 with the supercritical working fluid 350. In some embodiments, the supercritical working fluid 350 may be received by the cooling system 352 from the working fluid circuit 202. The cooling system 352 may utilize the supercritical working fluid 350, or a cooling stream including the supercritical working fluid 350, to remove heat from the magnetic liquid seal 306 as the heat is generated during operation. In certain embodiments, the heated supercritical working fluid 359 may be recycled back into the working fluid circuit 202, for example, at a point upstream from the power turbine 228 and/or upstream from the drive turbine 264, to recover and utilize the heat generated by the magnetic liquid seal 306 to generate useful electricity. In this way, the supercritical working fluid 350 may be employed to utilize the heat generated by the magnetic liquid seal 306 in the working fluid circuit 202, thereby increasing the efficiency of the working fluid circuit 202.

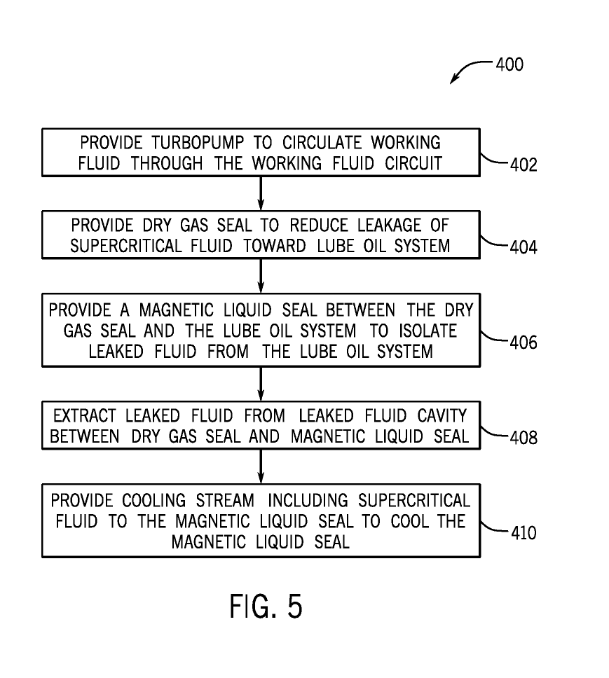

FIG. 5 illustrates an embodiment of a method 400 for recovering the leaked fluid 336 in the turbopump 260. The method 400 includes providing and utilizing the turbopump 260 to circulate working fluid through the working fluid circuit 202 (block 402) and providing and utilizing the dry gas seal 304 to reduce leakage of supercritical fluid toward the lube oil system 334 (block 404). The method 400 further includes providing and utilizing the magnetic liquid seal 306 between the dry gas seal 304 and the lube oil system 334 to isolate the leaked fluid 336 from the lube oil system 334 (block 406) and extracting the leaked fluid 336 from the fluid leakage cavity 305 between the dry gas seal 304 and the magnetic liquid seal 306 (block 408). Additionally, the method 400 includes utilizing a cooling stream to cool the magnetic liquid seal 306 by providing the cooling stream including supercritical fluid to the magnetic liquid seal 306 (block 410).

It should be noted that although in the illustrated embodiments, the magnetic liquid seal 306 is described as a feature of the turbopump 260, in other embodiments, the magnetic liquid seal 306 may be used in other components of the system. Indeed, the magnetic liquid seal 306 may be utilized in standalone turbines, pumps, or other compressors. For example, in one embodiment, the magnetic liquid seal 306 may be utilized in the power turbine 228.

It is to be understood that the present disclosure describes several exemplary embodiments for implementing different features, structures, or functions of the invention. Exemplary embodiments of components, arrangements, and configurations are described herein to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the present disclosure may include embodiments in which the first and second features are formed in direct contact, and may also include embodiments in which additional features may be formed interposing the first and second features, such that the first and second features may not be in direct contact. Finally, the exemplary embodiments described herein may be combined in any combination of ways, i.e., any element from one exemplary embodiment may be used in any other exemplary embodiment without departing from the scope of the disclosure.

Additionally, certain terms are used throughout the present disclosure and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the present disclosure and in the claims, the terms “including”, “containing”, and “comprising” are used in an open-ended fashion, and thus should be interpreted to mean “including, but not limited to”. All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B”, unless otherwise expressly specified herein.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A heat engine system, comprising:
a working fluid circuit having a high pressure side and a low pressure side and being configured to flow a working fluid therethrough, wherein at least a portion of the working fluid comprises supercritical carbon dioxide; and
a turbopump coupled to the working fluid circuit and comprising:
a pump portion;
a drive turbine coupled to the pump portion, fluidly coupled to and disposed between the high pressure side and the low pressure side, and configured to convert a pressure drop in the working fluid to mechanical energy;
a driveshaft coupled to the drive turbine and the pump portion and configured to drive the pump portion with the mechanical energy to enable the pump portion to circulate the working fluid through the working fluid circuit, wherein the driveshaft is at least partially contained within a housing;
a dry gas seal circumferentially disposed about the driveshaft between the driveshaft and the housing at a first axial location along the driveshaft;
a magnetic liquid seal circumferentially disposed about the driveshaft between the driveshaft and the housing at a second axial location along the driveshaft, wherein a fluid leakage cavity is formed between the dry gas seal at the first axial location and the magnetic liquid seal at the second axial location; and
an extraction port disposed in the housing and configured to enable recovery of a leaked fluid from the fluid leakage cavity.

2. The heat engine system of claim 1, further comprising a lube oil system disposed at a third axial location along the driveshaft, wherein the magnetic liquid seal is configured to seal off the fluid leakage cavity from the lube oil system.

3. The heat engine system of claim 1, further comprising a leak recapture system fluidly coupled to the extraction port and comprising a compressor configured to compress the leaked fluid.

4. The heat engine system of claim 3, wherein the leak recapture system further comprises a leak recapture storage vessel configured to receive the compressed leaked fluid from the compressor for storage.

5. The heat engine system of claim 3, wherein the compressor is fluidly coupled to the working fluid circuit and configured to provide the compressed leaked fluid to the working fluid circuit.

6. The heat engine system of claim 1, wherein the magnetic liquid seal comprises a magnet, a first pole piece, a second pole piece, a magnetically permeable shaft, and a ferrofluid, and wherein the ferrofluid is configured to form a sealing ring about the magnetically permeable shaft in a gap formed between the magnetically permeable shaft and the first and second pole pieces.

7. The heat engine system of claim 1, comprising a cooling system fluidly coupled to the working fluid circuit and the magnetic liquid seal and configured to provide the working fluid in a supercritical state to the magnetic liquid seal to cool the magnetic liquid seal.

8. A heat engine system, comprising:
a working fluid circuit having a high pressure side and a low pressure side and being configured to flow a working fluid therethrough, wherein at least a portion of the working fluid circuit contains the working fluid in a supercritical state;
a turbopump fluidly coupled to the working fluid circuit between the low pressure side and the high pressure side, and being configured to circulate the working fluid within the working fluid circuit; and
a magnetic liquid seal disposed in the turbopump and comprising a ferrofluid and a magnet configured to maintain the ferrofluid in a ring shape to seal a fluid leakage cavity of the turbopump from a lube oil system of the turbopump.

9. The heat engine system of claim 8, wherein the turbopump comprises a drive turbine configured to generate mechanical energy, a pump portion, and a driveshaft coupled to the drive turbine and the pump portion and configured to drive the pump portion with the mechanical energy to enable the pump portion to circulate the working fluid through the working fluid circuit.

10. The heat engine system of claim 9, wherein the turbopump comprises a dry gas seal circumferentially disposed about the driveshaft, and the fluid leakage cavity is axially disposed between the dry gas seal and the magnetic liquid seal along the driveshaft.

11. The heat engine system of claim 8, wherein the turbopump comprises an extraction port disposed therein and configured to enable recovery of a leaked fluid from the fluid leakage cavity.

12. The heat engine system of claim 11, further comprising a leak recapture compressor configured to receive the leaked fluid from the extraction port and to compress the leaked fluid.

13. The heat engine system of claim 8, further comprising a cooling system fluidly coupled to the working fluid circuit and the magnetic liquid seal and configured to transfer the working fluid from the working fluid circuit to the magnetic liquid seal to cool the magnetic liquid seal.

14. A heat engine system, comprising:
a working fluid circuit having a high pressure side and a low pressure side and being configured to flow a working fluid therethrough, wherein the working fluid is in a supercritical state in at least a portion of working fluid circuit;
a turbopump coupled to the working fluid circuit and comprising a pump portion and a drive turbine coupled to the pump portion via a driveshaft, wherein the driveshaft is at least partially contained within a housing;
a dry gas seal circumferentially disposed about the driveshaft between the driveshaft and the housing at a first axial location along the driveshaft;
a magnetic liquid seal circumferentially disposed about the driveshaft between the driveshaft and the housing at a second axial location along the driveshaft, wherein a fluid leakage cavity is formed between the dry gas seal at the first axial location and the magnetic liquid seal at the second axial location; and
a cooling system fluidly coupled to the working fluid circuit and the magnetic liquid seal and configured to transfer the working fluid from the working fluid circuit to the magnetic liquid seal to cool the magnetic liquid seal.

15. The heat engine system of claim 14, further comprising an extraction port disposed in the housing and configured to enable recovery of a leaked fluid from the fluid leakage cavity.

16. The heat engine system of claim 15, further comprising a leak recapture compressor configured to receive the leaked fluid from the extraction port and to compress the leaked fluid.

17. The heat engine system of claim 15, further comprising a condenser configured to receive the leaked fluid from the extraction port and to condense the leaked fluid.

18. The heat engine system of claim 14, further comprising a lube oil system disposed at a third axial location along the driveshaft, wherein the magnetic liquid seal is configured to seal the fluid leakage cavity from the lube oil system.

19. The heat engine system of claim 14, wherein the magnetic liquid seal comprises a magnet, a first pole piece, a second pole piece, a magnetically permeable shaft, and a ferrofluid, and wherein the ferrofluid is configured to form a sealing ring about the magnetically permeable shaft in a gap formed between the magnetically permeable shaft and the first and second pole pieces.

20. The heat engine system of claim 14, wherein the working fluid comprises supercritical carbon dioxide.

21. A heat engine system, comprising:
a working fluid circuit having a high pressure side and a low pressure side and being configured to flow a working fluid therethrough, wherein at least a portion of the working fluid comprises supercritical carbon dioxide;
a heat exchanger configured to be fluidly coupled to and in thermal communication with the working fluid in the high pressure side of the working fluid circuit, wherein the heat exchanger is configured to transfer thermal energy from a heat source stream to the working fluid in the high pressure side;
a power turbine fluidly coupled to and disposed between the high pressure side and the low pressure side of the working fluid circuit and configured to convert a pressure drop in the working fluid to mechanical energy;
a driveshaft coupled to the power turbine and configured to drive a device with the mechanical energy, wherein the driveshaft is at least partially contained within a housing;
a dry gas seal circumferentially disposed about the driveshaft between the driveshaft and the housing at a first axial location along the driveshaft;
a magnetic liquid seal circumferentially disposed about the driveshaft between the driveshaft and the housing at a second axial location along the driveshaft, wherein a fluid leakage cavity is formed between the dry gas seal at the first axial location and the magnetic liquid seal at the second axial location; and
an extraction port disposed in the housing and configured to enable recovery of a leaked fluid from the fluid leakage cavity.

22. The heat engine system of claim 21, further comprising a leak recapture system fluidly coupled to the extraction port and comprising a compressor configured to compress the leaked fluid.

23. The heat engine system of claim 22, wherein the leak recapture system further comprises a leak recapture storage vessel configured to receive and store the compressed leaked fluid from the compressor.

24. The heat engine system of claim 22, wherein the compressor is fluidly coupled to the working fluid circuit and configured to provide the compressed leaked fluid to the working fluid circuit.

25. A system, comprising:
a seal cartridge, comprising:
a housing defining a passageway configured to receive a driveshaft;
a dry gas seal circumferentially disposed about the passageway within the housing at a first axial location along the housing;
a magnetic liquid seal circumferentially disposed about the passageway within the housing at a second axial location along the housing, wherein a fluid leakage cavity is formed between the dry gas seal at the first axial location and the magnetic liquid seal at the second axial location; and
an extraction port disposed in the housing and configured to enable recovery of a leaked fluid from the fluid leakage cavity.

26. The system of claim 25, wherein the seal cartridge is configured to be disposed in a gas compressor, a power turbine, or a turbopump.
